(19) United States
(12) Patent Application Publication
(10) Pub. No.: US 2013/0087309 A1
(43) Pub. Date: Apr. 11, 2013

(54) SUBSTRATE SUPPORT WITH TEMPERATURE CONTROL

(71) Applicants: LEON VOLFOVSKI, Mountain View, CA (US); MAYUR G. KULKARNI, San Jose, CA (US)

(72) Inventors: LEON VOLFOVSKI, Mountain View, CA (US); MAYUR G. KULKARNI, San Jose, CA (US)

(73) Assignee: APPLIED MATERIALS, INC., Santa Clara, CA (US)

(21) Appl. No.: 13/270,280

(22) Filed: Oct. 11, 2011

(51) Int. Cl. F25B 29/00; H05B 3/00

(52) U.S. Cl. 165/61; 219/385

(57) ABSTRACT

Embodiments of substrate supports with temperature control are provided herein. In some embodiments, a substrate support includes a first member to distribute heat to a substrate when present above a first surface of the first member; a heater coupled to the first member and having one or more heating zones to provide heat to the first member; a second member disposed beneath the first member in a spaced apart relation to the first member to at least partially define a gap between the first member and the second member, the second member fixed relative to the first member; and a plate movably disposed in the gap such that a distance between the plate and the first and second members can be selectively controlled. In some embodiments, the position of plate in the gap controls the rate of heat transfer from the first member to the plate.

### FIELD

Embodiments of the present invention generally relate to substrate processing equipment, and more specifically to substrate supports for use in substrate processing equipment.

### BACKGROUND

As the critical dimensions of devices continue to shrink, improved control over processes, such as heating, cooling, or the like may be required. For example, a substrate support may include a heater to provide a desired temperature of a substrate disposed on the substrate support during processing.

The inventors have provided embodiments of substrate supports having enhanced temperature control.

### SUMMARY

Embodiments of substrate supports with temperature control are provided herein. In some embodiments, a substrate support comprising a first member to distribute heat to a substrate when present above a first surface of the first member; a heater coupled to the first member and having one or more heating zones to provide heat to the first member; a second member disposed beneath the first member in a spaced apart relation to the first member to at least partially define a gap between the first member and the second member, the second member fixed relative to the first member; and a plate movably disposed in the gap such that a distance between the plate and the first and second members can be selectively controlled. In some embodiments, the position of plate in the gap controls the rate of heat transfer from the first member to the plate.

In some embodiments, a substrate support includes a first member to distribute heat to a substrate when present above a first surface of the first member; a heater coupled to the first member and having one or more heating zones to provide heat to the first member; a second member disposed beneath the first member in a spaced apart relation to the first member to at least partially define a gap between the first member and the second member, the second member fixed relative to the first member; a plate movably disposed in the gap such that a distance between the plate and the first and second members can be selectively controlled, wherein the position of plate in the gap controls the rate of heat transfer from the first member to the plate; a cylindrical body disposed about and supporting the first member, the cylindrical body enclosing the gap formed between the first and second members; an actuator coupled to the plate to move the plate relative to the first and second members; and a base having the second member and the cylindrical body disposed on the base, wherein the base has a volume that is separated from the gap by the second member and wherein the atmosphere of the volume is independently controllable with respect to an atmosphere of the gap.

In some embodiments, a substrate support includes a first member to distribute heat to a substrate when present above a first surface of the first member; a heater coupled to the first member and having one or more heating zones to provide heat to the first member; a second member disposed beneath the first member in a spaced apart relation to the first member to at least partially define a gap between the first member and the second member, the second member fixed relative to the first member; a plate movably disposed in the gap such that a distance between the plate and the first and second members can be selectively controlled, wherein the position of plate in the gap controls the rate of heat transfer from the first member to the plate; a cylindrical body disposed atop the second member and disposed about and supporting the first member, the cylindrical body enclosing the gap formed between the first and second members; an actuator assembly coupled to the cooling plate through the second member to move the cooling plate relative to the first and second members, the actuator assembly including at least three plate support pins, each plate support pin moveably disposed through a corresponding opening in the second member to contact a backside surface of the cooling plate; and a base having the second member disposed on the base, wherein the base has a volume that is separated from the gap by the second member and wherein the atmosphere of the volume is independently controllable with respect to an atmosphere of the gap. In some embodiments, the substrate support further includes an active cooling mechanism disposed in at least one of the cooling plate or the second member.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic side view of a substrate support in accordance with some embodiments of the present invention.

FIG. 2 depicts a schematic side view of a substrate support in accordance with some embodiments of the present invention.

FIG. 3 depicts a schematic side view of a substrate support in accordance with some embodiments of the present invention.

FIGS. 4A-C depict cross-sectional side views of portions of substrate supports in accordance with some embodiments of the present invention.

FIGS. 5A-C depict cross-sectional side views of portions of substrate supports in accordance with some embodiments of the present invention.

FIG. 6 depicts a top view of a multi-zone heater in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of substrate supports having enhanced temperature control are disclosed herein. Embodiments of the inventive substrate support may advantageously facilitate one or more of heating a substrate, maintaining the temperature of a substrate, or distributing heat to a substrate in a desired profile. Further, the inventive substrate support may improve process throughput and/or extend substrate support lifetime as discussed below.

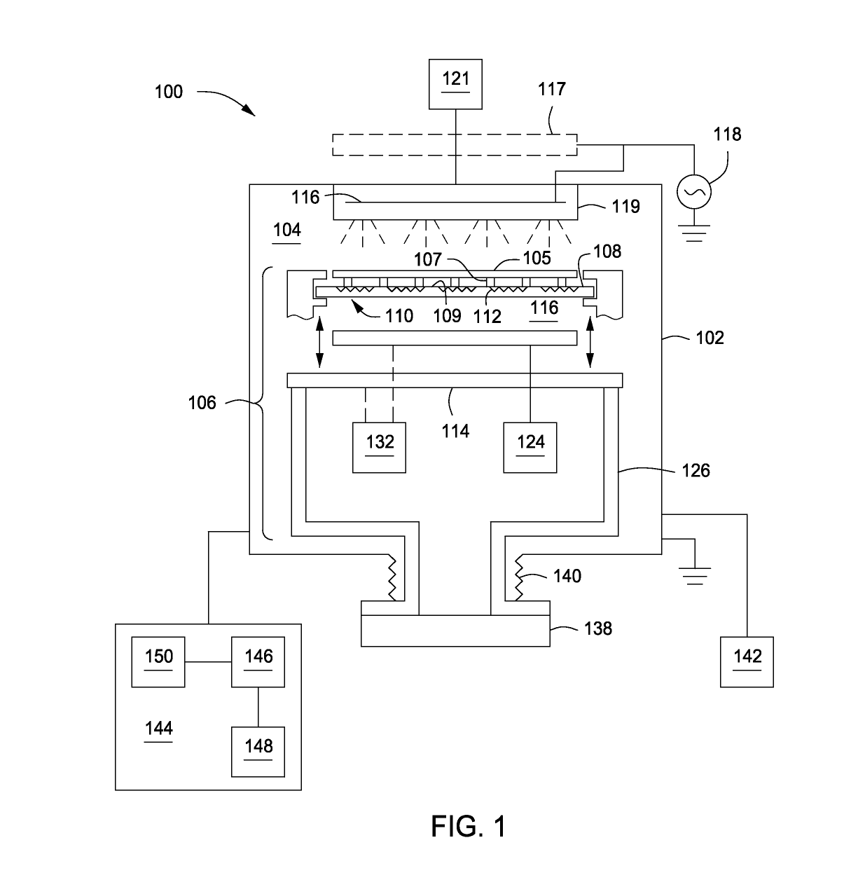

FIG. 1 depicts a schematic view of a substrate processing system in accordance with some embodiments of the present invention. In some embodiments, an apparatus 100 for processing a substrate may include a process chamber 102 having a processing volume 104 and a substrate support 106 disposed in the processing volume 104 for supporting a substrate 105. The process chamber 102 may comprise walls formed of conductive materials, such as aluminum (Al) or the like. In some embodiments, for example, when the process chamber 102 is configured for capacitively or inductively coupled plasma applications, the process chamber may have a ceiling comprising a dielectric material. Exemplary process chambers may include any suitable process chamber, such as those configured to perform chemical vapor deposition (CVD), for example, metal CVD or any suitable deposition process, or those chambers configured for curing/annealing processes or the like. The process chamber 102 may be used for plasma or non-plasma processes. Exemplary plasma process chambers may include those used for generating one or more of a remote, inductively coupled, or capacitively coupled plasma. Suitable process chambers may include the DPS®, ENABLER®, ADVANTEDGE™, or other process chambers, available from Applied Materials, Inc. of Santa Clara, Calif. Other process chambers, including those from other manufacturers, may similarly be used.

Embodiments of the substrate support discussed herein may advantageously facilitate one or more of heating a substrate, maintaining the temperature of a substrate, or distributing heat to a substrate in a desired profile as discussed below. Further, the inventive substrate support may advantageously improve process throughput and/or extend substrate support lifetime. For example, a cleaning process, such as one using a fluorine based plasma, for example, formed from a process gas including nitrogen trifluoride (NF₃) or any suitable fluorine-containing gas, may be employed periodically, after each substrate is processed or the like to clean the process chamber. For example, the inventive substrate support may facilitate rapid cooling of elements of the substrate support such as those elements exposed to the cleaning process such as a first member 108 or other elements exposed to the processing volume 104. For example, an active cooling mechanism and/or a moveable plate 120 may be used to facilitate rapid cooling of the substrate support as discussed below. For example, rapidly cooling the substrate may improve throughput as a user may not need to wait for the substrate support to cool prior to initiating the cleaning process, and/or cooling the substrate support to lower temperatures may improve substrate lifetime as etch rates of a plasma used during the cleaning process may increase exponentially with temperature. Thus, the plasma may damage the exposed elements of the substrate support if not sufficiently cooled prior to initiating the cleaning process.

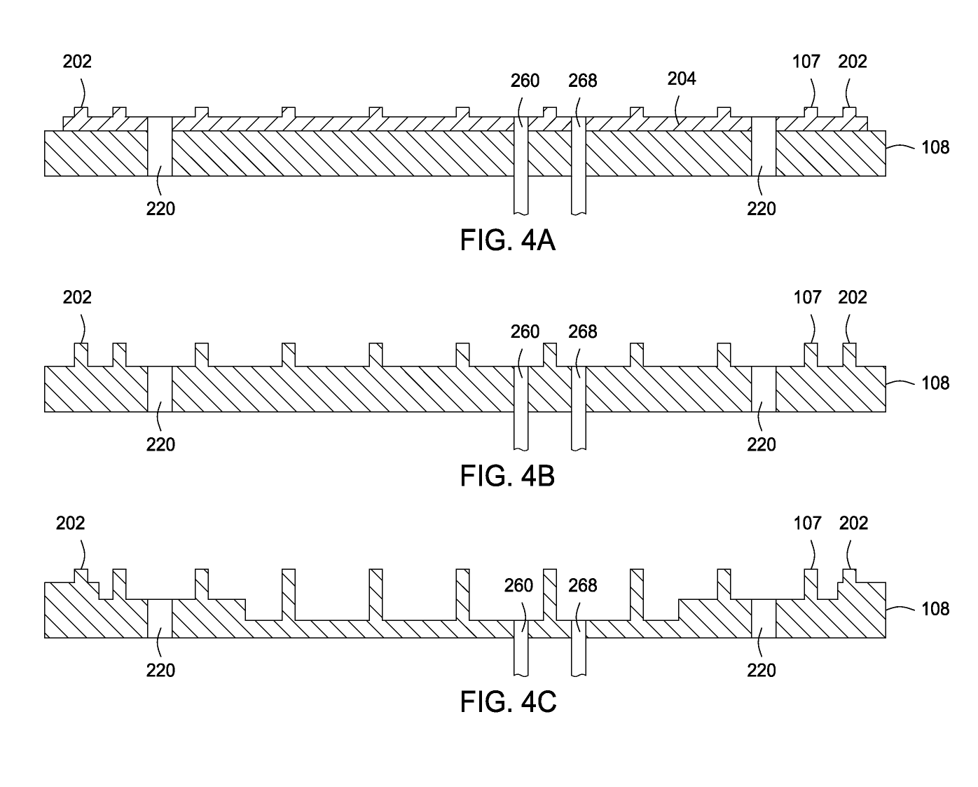

The substrate support 106 may include a first member 108 to distribute heat to the substrate 105 when present on the substrate support 106. The substrate 105 may rest on a plurality of support pins 107 disposed above a first surface 109 of the first member 108. The plurality of support pins 107 may support a backside surface of the substrate 105 when present on the substrate support 106. Several embodiments of the arrangement of the support pins 107 on the first member 108 are discussed below and illustrated in FIGS. 4A-C.

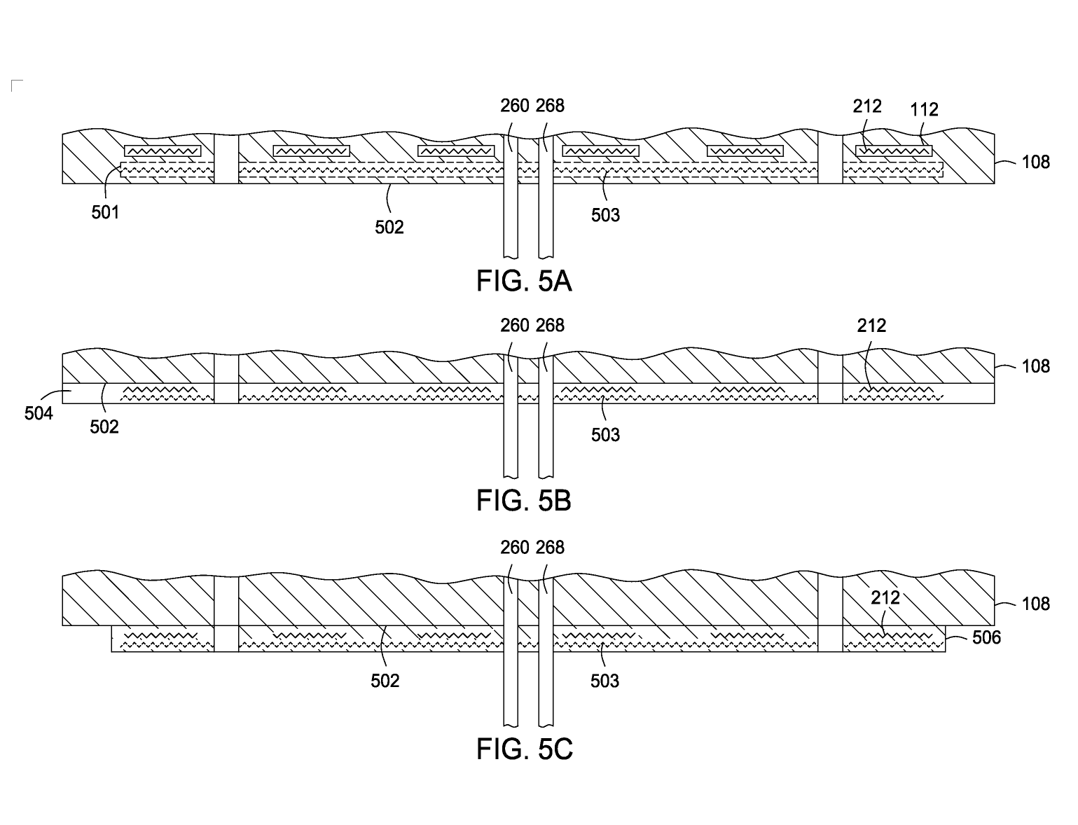

A heater 110 may be coupled to the first member 108 and may have one or more heating zones 112 to provide heat to the first member 108. Although drawn as being disposed within the first member 108 as illustrated in FIG. 1, there are many embodiments for coupling the one or more heating zones 112 to the first member 110, some of which are discussed below and illustrated in FIGS. 5A-C, 6. The heater 110 may be moveable relative to, for example, one or more of a showerhead 119 or the substrate support 105. For example, the first member 108 including the heater 110 may be fixed within the substrate support 106 as illustrated in FIGS. 1-3 and moveable relative to the showerhead 119 using a lift mechanism 138 (discussed below) to move the substrates support 106 in relation to the showerhead 119. Alternatively, (not shown) a separate actuator mechanism may be used to move the first member 108 including the heater 110 relative to the substrate support 106. The first member including the heater 110 may be moved for cool down purposes, for example, such as towards an active cooling mechanism as discussed below to reduce etch rates on exposed elements of the substrate support during a cleaning process.

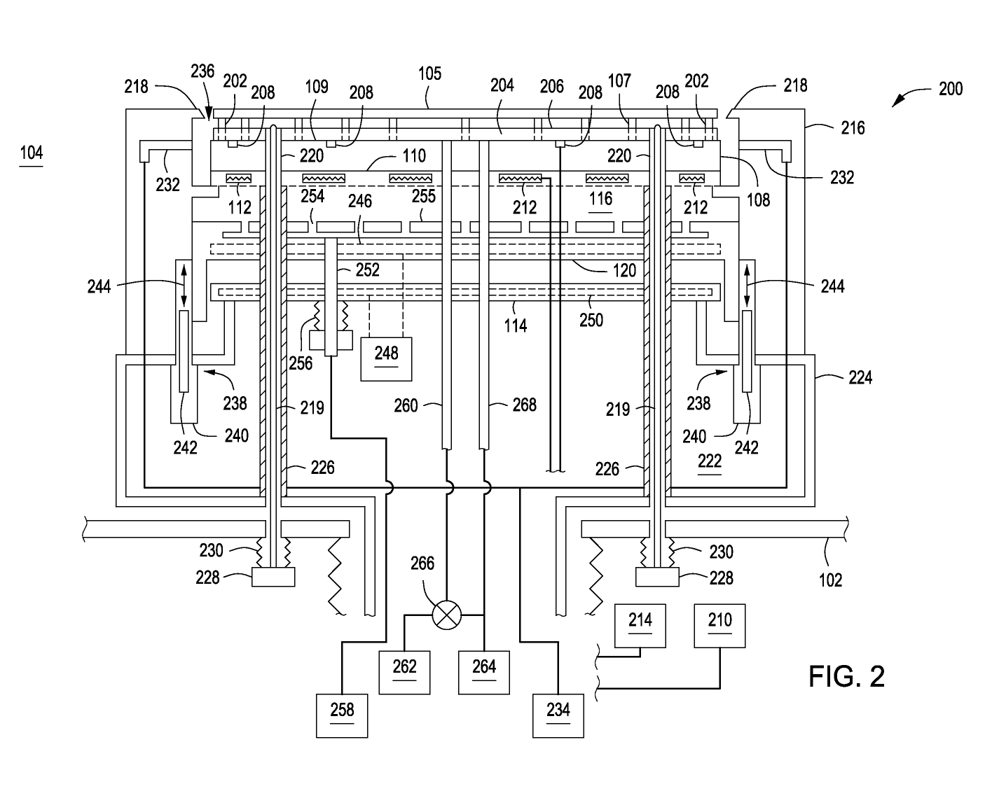

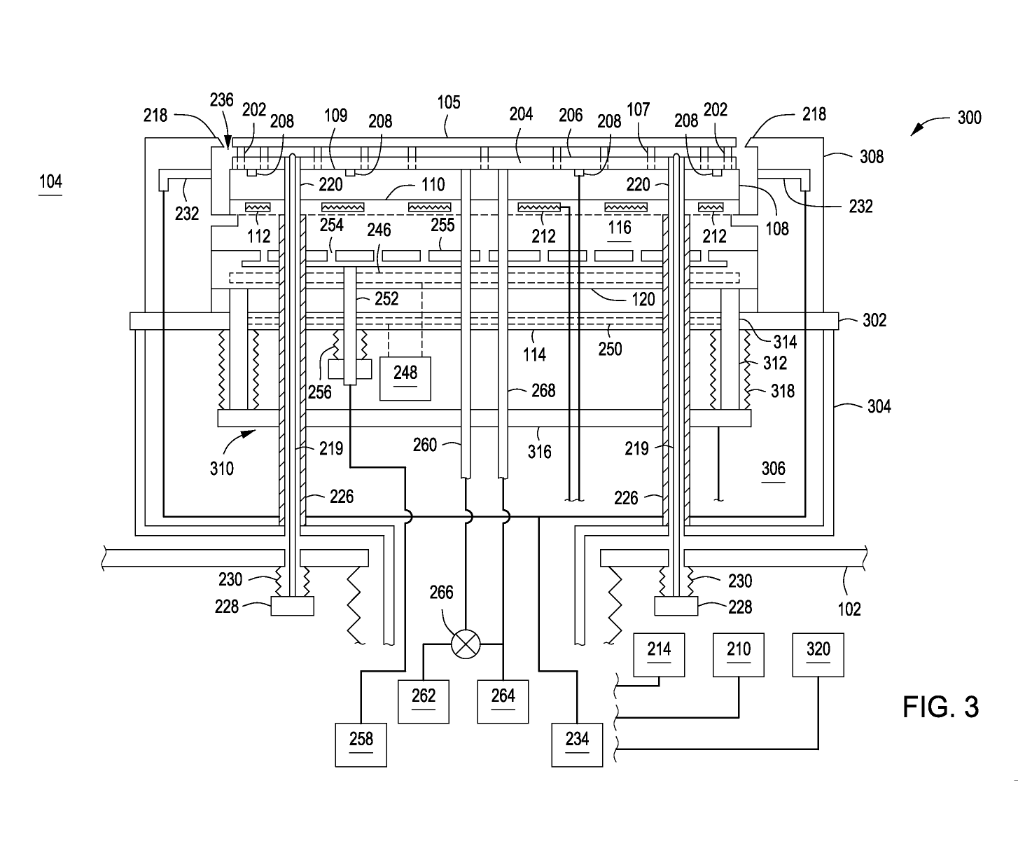

A second member 114 may be disposed beneath the first member 108 in a spaced apart relation to the first member 108 to at least partially define a gap 116 between the first member 108 and the second member 114. The second member 114 may be fixed relative to the first member 108. A plate 120 may be movably disposed in the gap 116 such that a distance between the plate 120 and the first and second members 108,114 can be selectively controlled. For example, the position of the plate 120 in the gap 116 may control the rate of heat transfer from the first member 108 to the plate 120. For example, at least one of the plate 120 or the second member 114 may include an active cooling mechanism 132. For example, the active cooling mechanism 132 may be utilized to actively cool at least one of the plate 120 or the second member 114 to control the rate of heat transfer from the first member 108 to the plate 120. For example, the plate 120 may be actively cooled by the active cooling mechanism 132 or alternatively, the plate 120 may be passively cooled by bringing the plate 120 into proximity or into contact with the second member 114 having the active cooling mechanism 132 disposed in the second member 114. An actuator 124 may be coupled to the plate 120 to move the plate 120 relative to the first and second members 108, 114 within the gap 116. Embodiments of the active cooling mechanism 132 and the actuator 124 are discussed below and illustrated in FIGS. 2-3.

The substrate support 106 may include a base 126 having the second member 114 disposed on the base 126. The base 126 may have a volume 128 that is separated from the gap 116 by the second member 114. The atmosphere of the volume 128 may be independently controllable with respect to an atmosphere of the gap 116. For example, the volume 128 may be at atmospheric pressure, held under an inert atmosphere, vacuum or the like.

In some embodiments, the substrate support 106 may provide temperatures ranging from about 450 degrees Celsius to about 600 degrees Celsius. However, embodiments of the substrate support disclosed herein are not limited to the above-mentioned temperature range. For example, the temperature may be lower, such as from about 150 degrees Celsius to about 450 degrees Celsius, or higher, such as greater than about 600 degrees Celsius.

Embodiments of a substrate support with temperature control are described in more detail below with respect to FIGS. 2-3. When possible the same numbers are used to described substantially similar components in each of FIGS. 1-3. FIG. 2 depicts a substrate support 200 in accordance with some embodiments of the present invention. The substrate support 200 may include the first member 108 to distribute heat to a substrate 105 when present above the first surface 109 (e.g., an upper surface) of the first member 108 and the heater 110 having one or more heating zones 112 to provide heat to the first member 108. Optionally, the heater 110 may further include a second heating zone 501 (as illustrated in FIGS. 5A-C) which underlies and spans the one or more heating zones 112. Further, (not shown) additional heating zones are possible below the second heating zone 501. Additionally, (not shown) the heater 110 may include layers below the heating zones for wire management. The second heating zone 501 may be utilized to achieve a base temperature or create a temperature boost across the first member 108 and the one or more heating zones 112 may be utilized for fine adjustment of the temperature in each location of the first member 108, for example, to achieve a uniform distribution of temperature on the substrate 105 or to achieve a desired non-uniform distribution of temperature on the substrate 105. Returning to FIG. 2, the heater 110 can be disposed below the first member 108. However, this is merely one exemplary embodiment of the heater 110. The heater 110 may be disposed in the first member 108, on a surface of the first member 108, or below the first member 108. Embodiments of the heater 106 are further discussed with respect to FIGS. 5A-C, below.

The substrate support 200 may include the plurality of substrate support pins 107 disposed a first distance above the first surface 109 of the first member 108. The plurality of substrate support pins 107 can support a backside surface of the substrate 105 when the substrate is present on the substrate support. The plurality of substrate support pins 107 may be surrounded by a support ring 202. The support ring 202 may contact the backside of the substrate 105 proximate the peripheral edge of the substrate 105. For example, the support ring 202 may be used, for example, to define a space or volume between the backside of the substrate 105 and the first member 108. For example, the space may be used to form a vacuum for securing the substrate 105 to support 200 and/or to provide a gas for heat transfer between the support 200 and the substrate 108 as discussed below.

In some embodiments, (as illustrated by the dotted lines proximate each support pin 107 and the support ring 202) each of the plurality of substrate support pins 107 and support ring 202 may extend from the first surface 109 of the first member 108 (e.g., the substrate support pins 107 and support ring 202 may be a part of, and formed in the first member 108). Alternatively, in some embodiments, a support layer 204 may be disposed on the first surface 109 of the first member 108 and each of the plurality of substrate support pins 107 and the support ring 202 may extend from a surface 206 of the support layer 204. In some embodiments, the support layer 204 and each of the plurality of substrate support pins 107 and the support ring 202 may be formed from the same material. For example, the support layer 204 and the each of the substrate support pins 107 and the support ring 202 may be a one-piece structure (illustrated in FIG. 4A and discussed below). The support layer and each of the plurality of substrate support pins 107 and the support ring 202 can be formed of suitable process-compatible materials having wear resistant properties. For example, materials may be compatible with the substrate, with processes to be performed on the substrate, or the like. In some embodiments, the support layer 204 and/or the substrate support pins 107 and/or the support ring 202 may be fabricated from a dielectric material. In some embodiments, the materials used to form the support layer 204 and/or the substrate support pins 107 and/or the support ring 202 may include one or more of a polyimide (such as KAPTON®), aluminum oxide (Al₂O₃), aluminum nitride (AlN), silicon dioxide (SiO₂), quartz, silicon nitride (Si₃N₄), silicon carbon (SiC) or the like. In some embodiments, for example for low temperature applications (e.g., at temperatures below about 200 degrees Celsius), the support layer 204 and/or the substrate support pins 107 and/or the support ring 202 may comprise KAPTON® or can be created using thermal/plasma spray.

The first member 108 may be utilized to distribute heat to the substrate 105. For example, the first member may act as a heat spreader to diffuse the heat provided by the one or more heating zones 112. In some embodiments, the first member 108 may include one or more temperature monitoring devices 208 embedded in the first member 108 or extending through the first member 108 to monitor the temperature being provided to the substrate 105 at one or more positions along the first surface 109 of the first member 108. The temperature monitoring devices 208 may include any suitable device for monitoring temperature, such as one or more of a temperature sensor, thermocouple, resistance temperature device (RTD), optical sensor, or the like. The one or more temperature monitoring devices 120 may be coupled to a controller 210 to receive temperature information from each of the plurality of the temperature monitoring devices 208. The controller 210 may further be used to control the heating zones 112 in response to the temperature information, as discussed below. The first member 108 may be formed of suitable process-compatible materials, such as materials having one or more of high thermal conductivity, high rigidity, and a low coefficient of thermal expansion. In some embodiment, the first member 108 may have a thermal conductivity of at least about 140 W/mK. In some embodiment, the first member 108 may have a coefficient of thermal expansion of about 2×10⁻⁵9×10⁻⁶/° K or less. Examples of suitable materials used to form the first member 102 may include one or more of aluminum (Al), copper (Cu) or alloys thereof, aluminum nitride (AlN), beryllium oxide (BeO), pyrolytic boron nitride (PBN), silicon nitride (Si₃N₄), aluminum oxide (Al₂O₃), silicon carbide (SiC), graphite coated with PBN, AlN coated with yttria (Y₂O₃), or the like. Other suitable coating that may be utilized with the first member 108 include diamond like coatings (DLCs) or the like.

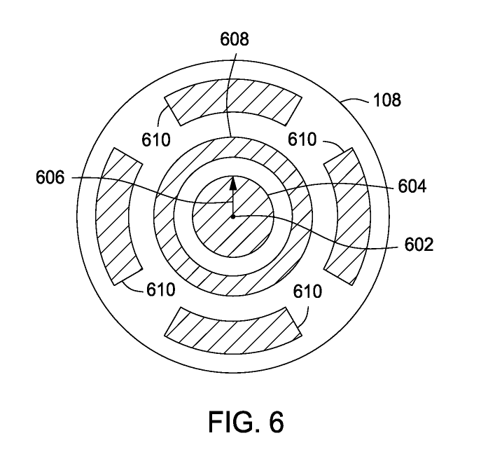

The heater 110 may include one or more resistive heating elements 212. For example, each of the one or more heating zones 112 includes one or more resistive heating elements 212. Although illustrated in FIGS. 1-3 and 5A-C as being uniformly distributed, the one or more heating zones 112 may be distributed in any suitable configuration that is desired to provide a desired temperature profile on the substrate 105. One exemplary configuration of the one or more heating zones is illustrated in FIG. 6, discussed below. Each of the resistive heating elements 212 may be coupled to a power source 214. The power source 214 may provide any suitable type of power, such as direct current (DC) or alternating current (AC), which is compatible with the resistive heating elements 212. The power source 214 may be coupled to and controlled by the controller 210 or by another controller (not shown), such as a system controller for controlling a process chamber having the substrate support disposed therein, or the like. In some embodiments, the power source 214 may further include a power divider (not shown) that divides the power provided to the resistive heating elements 212 in each heating zone 112. For example, the power divider may act in response to one or more of the temperature monitoring devices 208 to selectively distribute power to the resistive heating elements 212 in specific heating zones 112. Alternatively, in some embodiments, multiple power sources may be provided for the resistive heating elements in each respective heater zone.

The first member 108 maybe supported by a cylindrical body disposed about the first member 108 as illustrated in any of FIGS. 1-3. As illustrated in FIG. 2, a cylindrical body 216 may include a member support ring 218 disposed about the cylindrical body 216 and extending from an interior surface of the cylindrical body 216 towards a central axis thereof. The member support ring 218 may support the first member 108 as illustrated in FIG. 2. For example, suitable materials used to form the cylindrical body 216 may include one or more of aluminum nitride (AlN), aluminum oxide (Al₂O₃), stainless steel, or the like. Generally, materials for any of the various components of the substrate support may be selected based on chemical and thermal compatibility of the materials with each other and/or with a given process application.

The cylindrical body 216 may serve several functions, for example, such as an alignment guide, to provide a purge gas to the peripheral edge of the substrate 105 when present on the substrate support, to facilitate the motion of the plate 120 within the gap 116, or to enclose the gap 116 between the first and second members 108, 114. In some embodiments, the cylindrical body 216 may include an alignment guide 218 extending from a top surface of the cylindrical body 216 and about the plurality of substrate support pins 107. The alignment guide 216 may serve to guide, center, and/or align the substrate 105, such as with respect to the one or more heating zones 112 disposed below the substrate 105, for example, when the substrate is lowered onto the substrate support pins 107 by a plurality of lift pins 219 (lift pins holes 220 are illustrated in FIG. 2 and may extend through support layer 204 and first and second members 108, 114 and the plate 120). The lift pin holes 220 may be isolated from the gap 116, for example, by any suitable structure, such as tubes 226, which isolate the lift pine holes 220 from the gap 116. For example, the tubes 226 may prevent a gas provided to the gap 116 from reaching the backside of the substrate 105 via the lift pin holes 220. Further, the tubes 220 may further isolate the gap 116 from a volume 222 of a base 224 and/or the volume 222 of the base 224 from the processing volume 104. Each lift pin 219 may be coupled to a lift pin mechanism 228, the lift pin mechanism for raising and lowering the lift pin 219. The lift pin mechanism 228 may be coupled to the process chamber 102 via a bellows 230, such as a flexible hose, vacuum fitting or the like. The lift pin mechanism 228 and general configuration is merely exemplary and other embodiments are possible, such as each lift pins coupled to a common assembly or other suitable configurations. Alternatively, the lift pin mechanism 228 may be absent (not shown) and the lift pins may be fixed, for example, such as to a lower surface of the process chamber 102. In operation, the substrate support may raised and lowered relative to the fixed lift pins.

The alignment guide 218 may be formed of suitable process compatible materials, such as materials having wear resistant properties and/or a low coefficient of thermal expansion. The alignment guide 218 may be a single piece, such as part of the cylindrical body 216 or an assembly of multiple components coupled to the cylindrical body 216. In some embodiments, the alignment guide 218 may be fabricated from a dielectric material. For example, suitable materials used to form the alignment guide 218 may include one or more of CELAZOLE® PBI (polybenzimidazole), aluminum nitride (AlN), aluminum oxide (Al₂O₃), or the like.

The cylindrical body 216 may be utilized to provide a purge gas to the peripheral edge of the substrate 105 when present on the substrate support as discussed above. For example, cylindrical body 216 may include a plurality of conduits 232 disposed about the cylindrical body 216 to provide a gas proximate a peripheral edge of the substrate 105 when present on the substrate support. For example, the plurality of conduits 232 may be coupled to a gas source, such as a gas source 234 to provide a purge gas to limit the deposition of materials on the backside and edge of the substrate 105 during processing. For example, the purge gas may be provided to the backside of the substrate 105 via the plurality of conduits 232. As illustrated in FIG. 2, the plurality of conduits 232 may fluidly couple the purge gas provided by the gas source 234 to a gap 236 disposed proximate the edge of the substrate 105. For example, as illustrated in FIG. 2, the gap 236 may be formed between the alignment guide 218 and the peripheral edge of the substrate 105. The purge gas may include one or more of helium (He), nitrogen (N₂), or any suitable inert gas. The purge gas may be exhausted via the gap 236 and may limit or prevent process gases from reaching and reacting with a backside of the substrate 105 during processing. The purge gas may be exhausted from the process chamber via the exhaust system of the process chamber (not shown) to appropriately handle the exhausted purge gas.

The cylindrical body 216 may be used to enclose the gap 116 and to facilitate the motion of the plate 120 within the gap 116 between the first and second members 108, 114. For example, the cylindrical body 216 may include an actuator 238 to facilitate moving the plate 120 within the gap 116. For example, the actuator 238 may be disposed about and partially within the cylindrical body 216 to facilitate motion of the plate 120. As illustrated in FIG. 2, the cylindrical body 216 may be disposed on the base 224. The actuator 238 maybe partially disposed in the volume 222 of the base 224 and enter the cylindrical body 216 through the base 224. For example, as illustrated in FIG. 2, the actuator 238 may include one or more drive mechanisms 240 and one or more movable elements 242 coupled to each of the one or more drive mechanisms 240. For example, the one or more drive mechanisms 240 may be one or more of an electric motor, a pneumatic motor, a hydraulic motor, or the like. For example, the one or more movable elements 242 may be one or more of a piston, a cylinder (in embodiments of a singular movable element) or the like. The moveable elements 242 may move in an opening 244 formed in the cylindrical body 216 to facilitate movement of the plate 120 relative to the first and second members 108, 114. The one or more moveable elements 242 may be coupled to the plate 120 by any suitable coupling mechanism. For example, in some embodiments, the one or more moveable elements 242 may be physically coupled to the plate 120. Accordingly, when a physical coupling mechanism is utilized, the opening 244 may be fluidly coupled to the gap 116. Alternatively, in some embodiments, the one or more moveable elements 242 may be magnetically coupled to the plate 120. Accordingly, when a magnetic coupling mechanism is utilized, the opening 244 may be isolated from the gap 116. For example, a magnetic coupling mechanism may be advantageous for limiting corrosion of the actuator 238 by gases that may be present in the gap 116.

The plate 120 may be disposed in the gap 116 and moveable via the actuator 238 between the first and second members 108, 114. For example, suitable materials used to form the plate 120 may include one or more of aluminum (Al), aluminum alloys, stainless steel, aluminum nitride (AlN), aluminum oxide (Al₂O₃), or the like. The plate 120 may be actively cooled, for example, by the active cooling mechanism 132 as discussed above. For example, the active cooling mechanism 132 may be one or more of coolant channels, evaporative cooling, spray cooling, a Peltier chiller, or the like. In one exemplary embodiment, as illustrated in FIG. 2, the active cooling mechanism may include one or more cooling channel 246 disposed in the plate 120. The one or more cooling channels 246 may include an inlet and an outlet (not shown) which may be coupled through the gap 116 and the second member 114 to a coolant source 248 disposed in the volume 222 of the base 224 (as shown) or outside the process chamber 102 (not shown). The one or more coolant channels 246 may be coupled to the coolant source via a flexible hose, tube, or the like (not shown) such that the plate 120 can have a full range of motion between the first and second members 108, 144. Alternatively, or in combination, the active cooling mechanism may include one or more cooling channels 250 disposed in the second member 114 which may be coupled to the coolant source 248 similar to as described for the one or more cooling channels 246. As discussed above, the plate 120 may be passively cooled in some embodiments and have no active cooling mechanism. In such embodiments, the plate 120 may be passively cooled by an active cooling mechanism disposed in the second member 114. A coolant provided by the active cooling mechanism may include one or more of water, glycol, Galden®, nitrogen (N₂), air or the like. Further, the active cooling mechanism need not be uniform across the plate 120 or second member 114. For example, the cooling channels 246, 250 may be grouped in independently controllable zones or the like, and controlled to provide a desired temperature profile on the substrate 105.

The plate 120 may be used to provide a heat transfer gas to the gap 116, for example, to adjust heat transfer between the first member 108 and the plate 120. The flow rate of the heat transfer gas may be controlled to further adjust heat transfer between the first member 108 and the plate 120. For example, the plate 120 may include an inlet 252 for receiving a heat transfer gas and one or more outlets 254 for providing the heat transfer gas to the gap 116. Although draw as a single inlet 252, the inlet 252 may include one or more inlets. The inlet 252 may extend out of the backside of the plate 120 and through the second member 114 into the volume 222 of the base 224 as illustrated in FIG. 2. Alternatively, the inlet 252 may be flush with the backside of the plate 120 and coupled through a flexible hose, tube or the like through the second member 114 into the volume 222 (not shown). The inlet 252 may be mounted on a bellows 256 or another suitable flexible vacuum component within the volume 222, where the bellows 256 may isolate the volume 222 from the gap 116 while still permitting for motion of the plate 120 between the first and second members 108, 114. The inlet 252 may be coupled to a heat transfer gas source 258, which may be disposed outside the process chamber 102 as illustrated in FIG. 2. Generally, although gas sources, such as the heat transfer gas source 258, are illustrated as individual gas sources in FIG. 2. The various gas sources discussed herein may be part of a centralized gas panel (not shown) which provides all gases to the process chamber 102 or any suitable gas source apparatus. The heat transfer gas provided by the heat transfer gas source 258 may include one or more of helium (He), hydrogen (H₂), or the like. The one or more outlets 254 of the plate 120 may be disposed in any suitable arrangement on a first member-facing surface 255 of the plate 120 to provide the heat transfer gas to the gap 116. For example, the arrangement of the one or more outlets 254 may be uniform (as illustrated in FIG. 2) or in any suitable configuration to facilitate a desired temperature profile on the substrate 105. Further, the one or more outlets 254 may be arranged in independently controllable zones for similar reasons as discussed above for the one or more heat zones 112 or the cooling zones. The heat transfer gas may be exhausted by an exhaust system, such as exhaust system 142 (discussed below). For example, the heat transfer gas may be exhaust via an opening (not shown) fluidly coupling the gap 116 to the processing volume 104 or via an outlet (not shown) fluidly coupling the gap 116 to the exhaust system 142.

The second member 114 may be disposed atop the base 224. As discussed above, the active cooling mechanism 132 may be disposed in the second member 114, the plate 120 or a combination thereof. The second member 114 may be comprised of any suitable materials, such as aluminum (Al), Al alloys, stainless steel, copper (Cu), Cu alloys, Hastelloy® or the like. The second member may include one or more openings as illustrated in FIG. 2 to facilitate feed through of components, electrical wiring, gas conduits, or the like into the gap 116 or through the gap 116 to the first member 108 from the base 224. As discussed above, the volume 222 of the base 224 may be isolated from the gap 116. Accordingly, the openings in the second member 114 may be sealed such that the volume 222 and the gap 116 remain isolated.

In some embodiments, the second member 114 may facilitate the feed through of a conduit 260 which can at least one of provide a gas from a gas source 262 to the backside of the substrate 105 or provide a vacuum from a vacuum pump 264 to secure the substrate 105 to the substrate support as illustrated in FIG. 2. In some embodiments, the vacuum or gas may be alternately provided by a multi-way valve 266 coupling the vacuum pump 264 and gas source 262 to the conduit 260. For example, the gas provided by the conduit 260 may be utilized to improve heat transfer between the first member 108 and the substrate 105. In some embodiments, the gas is helium (He). For example, in operation, the vacuum pump 264 may be used to secure the substrate 105 to the substrate support. After the substrate 105 is secured, the gas source 262 may provide a gas to the space between the substrate 105 and the first member 108 to improve heat transfer. The conduit 260 may include a flexible section (not shown), such as a bellows or the like. Such flexibility in the conduit 260 may be helpful, for example, during thermal deformation or expansion of the substrate support during heating. Further, a second conduit 268 similar to the conduit 260 may be provide to exhaust the gas provided by the gas source 262 through the conduit 260 as illustrated in FIG. 2. The second conduit 268 may be coupled to the vacuum pump 264 (as shown) or to another vacuum pump, such as shared chamber pump or an individual pump exclusively coupled to the second conduit 268 (not shown). Generally, similar to gas sources as discussed above, pumping components, such as vacuum pumps or the like, can be individual pumps coupled to each component or shared components, such as a common chamber pump which may be used by all components of the process chamber 102.

Other embodiments of the substrate support are possible. For example, FIG. 3 depicts a substrate support 300 in accordance with some embodiments of the present invention. For example, the substrate support 300 is substantially similar to the substrate support 200. The substrate support 300 may differ in an actuator lifting the plate 120, and the shape and/or connectivity of the cylindrical body, the second member and the base.

For example, as illustrated in FIG. 3, the substrate support 300 includes a base 302 having the second member 302 disposed thereon. The second member spans the base 304 and has portions exposed to the processing volume 104, the gap 116 and a volume 306 of the base 304. For example, as illustrated in FIG. 2, the second member 114 may be disposed between the gap 116 and the volume 222 within the cylindrical body 216 and have no exposure to the processing volume 104. The second member 302 may be substantially similar to the second member 114 in other aspects as discussed above, such as active cooling and the like. Similarly, the base 304 may be substantially similar to the base 224 in other aspects as discussed above with the exception of shape as illustrated in FIG. 3. A cylindrical body 308 may be disposed about and supporting the first member 108 as illustrated in FIG. 3. The cylindrical body 308 may be disposed atop the second member 302 as shown. The cylindrical body 308 may be substantially similar to the cylindrical body 216 in other aspects such as providing a purge gas, forming an alignment guide, enclosing the gap 116, and the like.

As illustrated in FIG. 3, the substrate support 300 may include an actuator 310 coupled to the plate 120 through the second member 302 to move the plate 120 relative to the first and second members 108, 302. For example, the actuator 310 may include a plurality of plate support pins 312, wherein each plate support pin 312 may be moveably disposed through a corresponding opening 314 in the second member 302 to move the plate 120 relative to the first and second members 108, 302. For example, in some embodiments, at least three plate support pins 312 may be utilized to maintain the plate 120 in a substantially parallel orientation with the first and second members 108, 302 as the plate 120 is moved. The actuator 310 may include a supporting member 316 disposed in the volume 306 of the base 304, wherein the supporting member 316 may be coupled to and/or contact a lower end of each plate support pin 312 to move the support pins 312 to drive the motion of the plate 120. The supporting member 316 may be coupled to the second member 302 via a plurality of flexible elements 318, such as bellows, flexible hoses, or the like. Each flexible element 318 may be disposed about a corresponding plate support pin 312 such that the flexible element 318 isolates the volume 306 from the gap 116 as the plate support pins 312 are moved through the openings 314 in the second member 302. For example, the supporting member 316 may be coupled to a lift mechanism 320 to raise and lower the supporting member within the volume 306. Other elements of the substrate support 300, unless specifically mentioned above, may be substantially similar to those elements of the substrate support 200.

As discussed above, variations of the first member 108 are possible and some of which are illustrated in FIGS. 4A-C. In some embodiments, such variations may depend on the process being performed on the substrate 105 and/or the composition of the substrate 105. For example, depending on temperature requirements for a given process, the first member 108 may be formed of a material having a specific thermal conductivity or the like; however, such a material may contaminate the substrate 105 if the backside of the substrate 105 is exposed to the first surface 109 of the first member 108. Accordingly, the support layer 204 may be utilized under such conditions and be formed of a different material than the first member 108, where the different material will not contaminate the substrate 105. For example, FIG. 4A depicts an embodiment of the substrate support 108 which includes the support layer 204 and the plurality of support pins 107 extending from the support layer 204, and the first member 108, the support layer 204 and support pins 107 are formed from different materials than the first member 108.

Alternatively, depending on the process being performed on the substrate 105 and/or the composition of the substrate 105, the first member 108 and the plurality of substrate support pins 107 may be formed of the same material as illustrated in FIG. 4B. For example, wherein the material of the first member is compatible with the process being performed on the substrate 105 and/or the composition of the substrate 105, then embodiments of the first member as shown in FIG. 4B may be used. As the support layer 204 is integral with the first member 108 in FIG. 4B, a separate support layer 204 is not shown in FIG. 4B. However, the support layer 204 may be considered to be an upper portion of the first member 108.

Alternatively, depending on the process being performed on the substrate 105 and/or the composition of the substrate, the first member 108 may vary in thickness as illustrated in FIG. 4C. For example, the thickness variation along the first member 108 may facilitate a desired heating profile along the substrate 105 and/or compensate for non-uniformities in a process being performed on the frontside surface of the substrate 105, such as deposition, curing, baking, annealing, etching, and others. For example, in some embodiments, as illustrated in FIG. 4C, the first member 108 may increase in thickness from the center to an edge of the first member 108. However, the embodiments of FIG. 4C are merely illustrative, and the thickness of the first member 108 may be varied in any suitable manner to provide a desired heating profile along the substrate 105. As illustrated in FIG. 4C, when the thickness of the first member 108 is varied, the plurality of support pins 107 may have varying lengths to compensate for the thickness variation in the first member 108. As shown in FIG. 4C, each support pin 107 has a length such that it contacts a backside surface of the substrate 105 at about the same vertical height. The plurality of support pins 107 may be individually fashioned and coupled to the first member 108 as illustrated in FIG. 4C. Alternatively, (not shown) the plurality of support pins 107 may be integral with the first member 108, for example, similar to the embodiments of the support pins 107 shown in FIG. 4B.

As discussed above, variations of the heater 110 and coupling of the heater 110 to the first member 108 are possible. For example, several non-limiting variations of the heater 110 are illustrated in the embodiments shown in FIGS. 5A-D. FIGS. 5A-C depict a partial cross sectional view of the first member 108 and the heater 110 in an accordance with some embodiments of the invention. For example, elements, such as the temperature monitoring device 208, support pins 107, support layer 204 or other elements of the first member 108 illustrated in FIGS. 1-3 and 4A-C have been omitted, but may be used in accordance with any of the embodiments of the heater 110 illustrated in FIGS. 5A-D and described below.

For example, as shown in FIG. 5A, the heater 110 may be disposed in the first member 108. For example, the one or more resistive elements 212 may be disposed in the first member 108 in any suitable manner, such as arranged in heating zones 112, to provide a desired temperature profile to the substrate 105. For example, the one or more resistive elements 212 may be disposed at any suitable distance from a lower surface 502 of the first member 108 to provide the desired temperature profile. Although the heating zones 112 are illustrated as being disposed at the same distance from the lower surface 502 in FIG. 5A, the distance from the lower surface 502 may vary for one or more of the heating zones 112. Optionally, as discussed above, the heater 110 may include a second heat zone 501 which may be utilized to achieve a base temperature across the first member 108 or to provide a temperature boost as required. The second heat zone 501 may include one or more resistive elements 503, which may be uniformly dispersed throughout the second heat zone 501. Although draw as a single resistive element in FIGS. 5A-C, the element 503 may be one or more resistive elements 503.

In some embodiments, the heater 110 may include the one or more resistive heating elements 212 deposited onto the lower surface 502 of the first member 108. For example, deposition may include any suitable deposition technique for forming a desired pattern of heating zones 112. For example, the one or more resistive heating elements 212 may comprise platinum, tungsten, nichrome, INCONEL®, resistive ceramics or other suitable resistive heating materials. In some embodiments, after the deposition of the one or more resistive heating elements 212 is complete, a coating 504 may be used to cover the one or more heating elements disposed on the lower surface 502. For example, the coating 504 may cover the entire lower surface 502 as illustrated in FIG. 5B, or be limited to covering the one or more heating elements 212. The coating 504 may comprise an insulating material, such as a glass, ceramic, or the like. Optionally, prior to depositing the coating 504, the one or more resistive elements 503 may also be deposited below the one or more resistive heating elements 212. For example, the one or more resistive elements 212 and the one or more resistive elements 503 may be separated by an insulating layer (not shown) such as a dielectric layer or the like, which can be deposited prior to depositing the one or more resistive elements 503. Alternatively, the coating 504 may be deposited to cover the one or more resistive elements 212, and then the one or more resistive elements 503 may be deposited atop the coating 504. A second coating (not shown) may be deposited to cover the one or more resistive elements 503.

In some embodiments, as illustrated in FIG. 5C, the support may include a third member 506 disposed beneath the first member 108. The heater 110 may include the one or more resistive heating elements 212 disposed in the third member 506. For example, deposition may include any suitable deposition technique for forming a desired pattern of heating zones 112. For example, and similar to the embodiments of FIG. 5A, the one or more resistive elements 212—and optionally, the one or more resistive elements 503—may be disposed in the third member 506 in any suitable manner, such as arranged in heating zones 112, to provide a desired temperature profile to the substrate 105. Alternatively, the third member 306 may comprise two members (not shown), for example, a first member including the one or more resistive heating elements 212 and a second member including the one or more resistive heating elements 503. For example, the one or more resistive elements 212 may be disposed at any suitable distance from a lower surface 502 of the first member 108 to provide the desired temperature profile. Although the heating zones 112 are illustrated as being disposed at the same distance from the lower surface 502 in FIG. 5C, the distance from the lower surface 302 may vary for one or more of the heating zones 112. The third member 506 may be formed of suitable process-compatible materials, such as materials having one or more of high mechanical strength (e.g., a bending strength at least about 200 MPa), high electrical resistivity (e.g., at least about 10¹⁴ ohm-cm), a low coefficient of thermal expansion (e.g., no more than about 2×10⁻⁶5×10⁻⁶ /° K). Suitable materials may include one or more of silicon carbon (SiC), silicon nitride (Si₃N₄), aluminum nitride (AlN), aluminum oxide (Al₂O₃), beryllium oxide (BeO), pyrolytic boron nitride (PBN), graphite coated with PBN, AlN coated with yttria (Y₂O₃), or the like. Other suitable coating that may be utilized with the third member 506 may include diamond-like coatings (DLCs) or the like.

For example, one embodiment of a configuration of the one or more heating zones 112 arranged into six zones is illustrated in FIG. 6, although greater or fewer zones may also be used. As shown in a top view, the heating zones 112 may be disposed about a central axis 602 of the substrate support. The one or more heating zones 112 may include a first heating zone 604 having a first radius 606 extending from the central axis 602 (e.g., a central zone), a second heating zone 608 circumscribing the first heating zone 604 (e.g., a middle zone), and a third, fourth, fifth, and sixth heating zones 610 disposed about the second heating zone 608 (e.g., a plurality of outer zones). In some embodiments, and as shown, each of the four heating zones 610 may correspond to about one quarter of the outer region of the substrate support. In some embodiments, a temperature monitoring device (such as the temperature monitoring device 208 discussed above) may be provided to sense data corresponding to the temperature within each zone (or at a desired location within each zone). In some embodiments, each temperature monitoring device is an RTD. Each of the temperature monitoring devices may be coupled to the controller (such as controller 210 discussed above) to provide feedback control over each corresponding heating zone 112.

Returning to FIG. 1, the process chamber 102 may include a showerhead 119 coupled to a gas panel 121 as illustrated in FIG. 1 to provide one or more process gases to the processing volume 104 to deposit a material on the substrate 105 or the like. The showerhead 119 is merely one exemplary chamber component for delivering one or more process gases to the processing volume 104. Alternatively or in combination, the one or more process gases may be delivered to the processing volume 104 via side injection ports (not shown) disposed about the walls of the process chamber 102, or gas inlets disposed is other regions of the process chamber. Alternatively or in combination, the one or more process gases may be delivered to a remote volume (not shown) where a plasma is formed and then flowed into the processing volume 104.

For example, when the process chamber 102 may be configured as a capacitively coupled plasma apparatus. In a capacitively coupled plasma apparatus, an RF electrode 116 may be disposed above the substrate support 106 as illustrated in the primary view in FIG. 1. The second RF electrode 116 may be disposed in the processing volume 104 and an RF source 118 may be coupled to the RF electrode 116 as illustrated in the primary view in FIG. 1. For example, the RF electrode 116 may be a showerhead (not shown), or part of and/or disposed in a showerhead 119 as illustrated in FIG. 1, or any suitable embodiment of an overhead electrode used in a capacitively coupled plasma apparatus. For example, a second RF electrode (not shown), such as to provide an RF return path, may be disposed in the substrate support 106 (not shown). In some embodiments, the process chamber 102 may be configured as an inductively coupled plasma apparatus. In such embodiments, the RF electrode (i.e., an RF electrode 117 as illustrated in phantom in FIG. 1) may be disposed external to the processing volume 104 of the process chamber 102 and coupled to the RF source 118.

The substrate 105 may enter the process chamber 102 via an opening (not shown) in a wall of the process chamber 102. The opening may be selectively sealed via a slit valve, or other mechanism for selectively providing access to the interior of the chamber through the opening. The substrate support 106 may be coupled to a lift mechanism 138 that may control the position of the substrate support 106 between a lower position suitable for transferring substrates into and out of the chamber via the opening and a selectable upper position (as shown) suitable for processing. The process position may be selected to maximize process uniformity for a particular process. When in at least one of the elevated processing positions, the substrate support 106 may be disposed above the opening to provide a symmetrical processing region. The lift mechanism 138 may be coupled to the process chamber 102 via a bellows 140 or other flexible vacuum hose to maintain a desired pressure in the processing volume 104 when the substrate support 106 is moved. The lift mechanism 138 may be grounded, for example such as by the process chamber 102 through the bellows 140.

The apparatus may include additional components that are common to process chambers, such as an exhaust system 142 for removing excess process gases, processing by-products, or the like, from the processing volume 104 of the process chamber 102. For example, the exhaust system 142 may include a vacuum pump coupled to a pumping plenum via a pumping port for pumping out the exhaust gases from the process chamber 102 (not shown), or any suitable exhaust system. For example, the vacuum pump may be fluidly coupled to an exhaust outlet for routing the exhaust as required to appropriate exhaust handling equipment. A valve (such as a gate valve, z-motion valve, or the like) may be disposed in the pumping plenum to facilitate control of the flow rate of the exhaust gases in combination with the operation of the vacuum pump.

To facilitate control of the process chamber 102 as described above, a controller 144 comprises a central processing unit (CPU) 146, a memory 148, and support circuits 150 for the CPU 146 and facilitates control of the components of the chamber 102. The controller 144 may be one of any form of general-purpose computer processor that can be used in an industrial setting for controlling various chambers and sub-processors. The memory 148, or computer-readable medium, of the CPU 146 may be one or more of readily available memory such as random access memory (RAM), read only memory (ROM), floppy disk, hard disk, or any other form of digital storage, local or remote. The support circuits 150 are coupled to the CPU 146 for supporting the processor in a conventional manner. These circuits include cache, power supplies, clock circuits, input/output circuitry and subsystems, and the like. The methods performed in the process chamber 102, or at least portions thereof, may be stored in the memory 148 as a software routine. The software routine may also be stored and/or executed by a second CPU (not shown) that is remotely located from the hardware being controlled by the CPU 146.

Thus, embodiments of substrate supports have been disclosed herein. The inventive substrate support may advantageously facilitate one or more of heating a substrate, maintaining the temperature of a substrate, or uniformly distributing heat to or removing heat from a substrate, or create selectable temperature non-uniformities or a desired temperature profile on a substrate.

While the foregoing is directed to embodiments of the present invention, other and further embodiments of the invention may be devised without departing from the basic scope thereof.

1. A substrate support, comprising:
a first member to distribute heat to a substrate when present above a first surface of the first member;
a heater coupled to the first member and having one or more heating zones to provide heat to the first member;
a second member disposed beneath the first member in a spaced apart relation to the first member to at least partially define a gap between the first member and the second member, the second member fixed relative to the first member; and
a plate movably disposed in the gap such that a distance between the plate and the first and second members can be selectively controlled.

2. The substrate support of claim 1, wherein the position of the plate in the gap controls the rate of heat transfer from the first member to the plate.

3. The substrate support of claim 1, wherein the plate further comprises:
an inlet for receiving a heat transfer gas; and
an outlet for providing the heat transfer gas to the gap formed between the first and second members.

4. The substrate support of claim 3, wherein at least one of the plate or the second member further comprises:
an active cooling mechanism.

5. The substrate support of claim 4, wherein the active cooling mechanism comprises one or more of cooling channels or a Peltier chiller disposed in the at least one of the plate or the second member.

6. The substrate support of claim 3, wherein the plate is passively cooled and the second member further comprises the active cooling mechanism.

7. The substrate support of claim of claim 1, further comprising:
a base having the second member disposed on the base, wherein the base has a volume that is separated from the gap by the second member and wherein the atmosphere of the volume is independently controllable with respect to an atmosphere of the gap.

8. The substrate support of claim 7, further comprising:
a cylindrical body disposed about and supporting the first member, the cylindrical body enclosing the gap formed between the first and second members.

9. The substrate support of claim 8, wherein the cylindrical body is disposed atop the base.

10. The substrate support of claim 8, wherein the cylindrical body is disposed atop the second member.

11. The substrate support of claim 8, wherein the cylindrical body further comprises:
one or more conduits disposed in the cylindrical body and about the first member to provide a purge gas to a substrate when present above the first surface of the first member.

12. The substrate support of claim 1, further comprising:
an actuator coupled to the plate to move the plate relative to the first and second members.

13. The substrate support of claim 12, wherein the actuator is one of physically or magnetically coupled to the plate.

14. The substrate support of claim 12, wherein the actuator further comprises:
an actuator assembly coupled to the plate through the second member to move the plate relative to the first and second members.

15. The substrate support of claim 14, wherein the actuator assembly further comprises:
at least three plate support pins, each plate support pin moveably disposed through a corresponding opening in the second member to contact a backside surface of the plate.

16. The substrate support of claim 1, wherein the first member further comprises:
a plurality of substrate support pins disposed a first distance above the first surface of the first member, the plurality of substrate support pins to support a backside surface of a substrate when present on the substrate support.

17. A substrate support, comprising:
a first member to distribute heat to a substrate when present above a first surface of the first member;
a heater coupled to the first member and having one or more heating zones to provide heat to the first member;
a second member disposed beneath the first member in a spaced apart relation to the first member to at least partially define a gap between the first member and the second member, the second member fixed relative to the first member;
a plate movably disposed in the gap such that a distance between the plate and the first and second members can be selectively controlled, wherein the position of plate in the gap controls the rate of heat transfer from the first member to the plate;
a cylindrical body disposed about and supporting the first member, the cylindrical body enclosing the gap formed between the first and second members;
an actuator coupled to the plate to move the plate relative to the first and second members; and
a base having the second member and the cylindrical body disposed on the base, wherein the base has a volume that is separated from the gap by the second member and wherein the atmosphere of the volume is independently controllable with respect to an atmosphere of the gap.

18. The substrate support of claim 17, further comprising:
an active cooling mechanism disposed in at least one of the plate or the second member.

19. A substrate support, comprising:
a first member to distribute heat to a substrate when present above a first surface of the first member;
a heater coupled to the first member and having one or more heating zones to provide heat to the first member;
a second member disposed beneath the first member in a spaced apart relation to the first member to at least partially define a gap between the first member and the second member, the second member fixed relative to the first member;
a plate movably disposed in the gap such that a distance between the plate and the first and second members can be selectively controlled, wherein the position of plate in the gap controls the rate of heat transfer from the first member to the plate;
a cylindrical body disposed atop the second member and disposed about and supporting the first member, the cylindrical body enclosing the gap formed between the first and second members;
an actuator assembly coupled to the cooling plate through the second member to move the cooling plate relative to the first and second members, the actuator assembly including at least three plate support pins, each plate support pin moveably disposed through a corresponding opening in the second member to contact a backside surface of the cooling plate; and
a base having the second member disposed on the base, wherein the base has a volume that is separated from the gap by the second member and wherein the atmosphere of the volume is independently controllable with respect to an atmosphere of the gap.

20. The substrate support of claim 19, further comprising:
an active cooling mechanism disposed in at least one of the cooling plate or the second member.
